(19) United States
(12) Patent Application Publication
(10) Pub. No.: US 2017/0199718 A1
(43) Pub. Date: Jul. 13, 2017

(54) METHOD FOR CALLING OUT MUSIC PLAYLIST BY HAND GESTURE

(71) Applicant: FiiO Electronics Technology Co., Ltd., Guangzhou (CN)

(72) Inventor: Guangsheng Zhang, Dongguan (CN)

(21) Appl. No.: 15/399,768

(22) Filed: Jan. 6, 2017

(30) Foreign Application Priority Data
Jan. 7, 2016 (CN) 201610012035.6

(51) Int. Cl. G06F 3/16; G06F 3/0481; G06F 3/0488

(52) U.S. Cl. CPC G06F 3/165; G06F 3/0488; G06F 3/0481

(57) ABSTRACT

The Invention discloses a method for calling out music playlist by hand gesture, comprising the following steps to: enter playing interface of music player, set up the corresponding plane coordinate system according to the playing interface, and set positive direction of X-axis and Y-axis. Define a hand gesture area in the playing interface, and conduct ACTION_MOVE operation in the hand gesture area to call out music playlist. By the corresponding gesture operations in the hand gesture area, the music player will directly pop up the music playlist, and the user may not click the button.

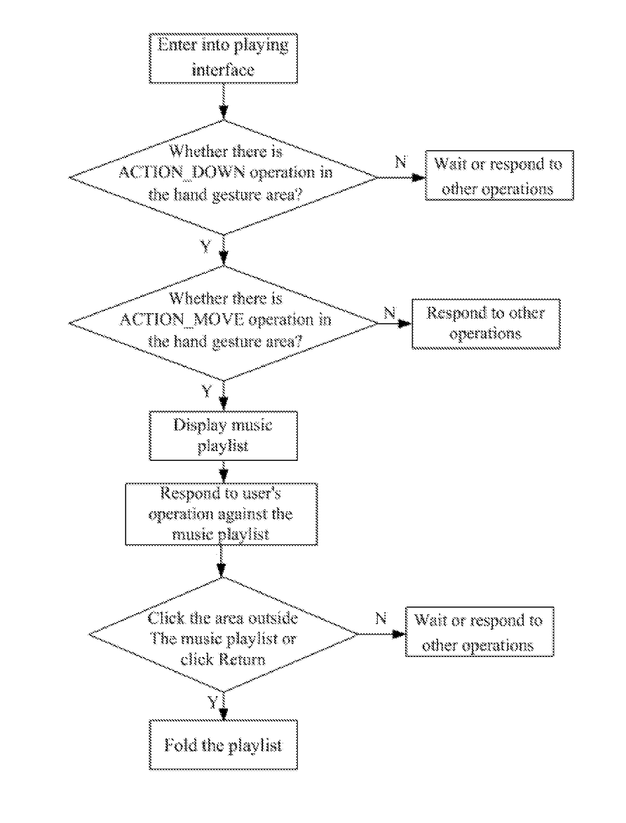

### CROSS REFERENCE TO RELATED APPLICATIONS

The present application claims the benefit of Chinese Patent Application No. 201610012035.6 filed on Jan. 7, 2016, the contents of which are hereby incorporated by reference.

### TECHNICAL FIELD

The Invention relates to the field of mobile terminal, in particular to a method for calling out music playlist by hand gesture.

### BACKGROUND ART

In using the current music player, the user need to click the button of “Playlist” on the music playing interface to open the intended music playlist; if the button icon is small, it is inconvenient to operate. Moreover, the device offers nothing new.

### SUMMARY OF THE INVENTION

The Invention provides a method for calling out music playlist by hand gesture, which addresses the problem in the prior art that the music playlist can be opened only by clicking the button.

The technical scheme of the Invention is realized as follows: a method for calling out music playlist by hand gesture, comprising the following steps:

(1) entering playing interface of music player, set up the corresponding plane coordinate system according to the playing interface (comprising album front cover area, lyrics area and ID3 area), and set positive direction of X-axis and Y-axis;

(2) defining a hand gesture area in the playing interface, which has overlap areas respectively with album front cover area, lyrics area and ID3 area;

(3) checking whether there is ACTION_DOWN operation in the hand gesture area; if any, record the coordinate values of the ACTION_DOWN location, and then go to the next step;

(4) judging whether there is ACTION_MOVE operation in the hand gesture area; if any, record the coordinate values of the ACTION_MOVE location, and then go to the next step;

(5) obtaining the displacement of ACTION_MOVE operation according to the coordinate values of the ACTION_DOWN location and of ACTION_MOVE termination location;

(6) judging whether the displacement of ACTION_MOVE operation and projection on X-axis are positive. If yes, go to the next step;

(7) displaying music playlist in the playing interface.

Further, judging whether there is ACTION_MOVE gesture on the music playlist, if yes, go to the next step; obtaining the displacement of ACTION_MOVE gesture and judge whether the projection of the displacement on Y-axis is positive; if yes, music playlist moves along the positive direction of Y-axis, otherwise, along the negative direction of Y-axis.

Further, judging whether there is ACTION_MOVE gesture on the playing interface and whether the displacement of ACTION_MOVE gesture projected on X-axis is negative, or whether there is ACTION_DOWN gesture in the area outside the music playlist; or whether to click Return, if yes, the music playlist is folded up.

Further, the music playlist contains a number of song entries, one side of which is provided with a dynamic mark for the current song played.

Further, there includes the following steps between Step (3) and Step (4): judging whether ACTION_DOWN operation is paused, if not, go to Step (4).

Further, there includes the following steps between Step (5) and Step (6): setting an ACTION-MOVE distance threshold, judge whether the distance of ACTION_MOVE operation exceeds or equals the ACTION-MOVE distance threshold, if yes, go to Step (6).

Further, the music playlist is provided with a number of hand gesture subareas, which are respectively set in the areas where the song entries are located;

Judge whether there is ACTION_MOVE gesture in the hand gesture subarea, if yes, judge whether the displacement of ACTION_MOVE gesture has projection along positive direction of X-axis;

If the displacement of ACTION_MOVE gesture has projection along positive direction of X-axis, popping up the music operation list, which comprises the corresponding configuration operation area of song entries and information list.

Further, judging whether the hand gesture subarea has ACTION_DOWN operation, if yes, the corresponding song entry will be played.

The beneficial effect of the Invention is that the music player will directly pop up music playlist by the corresponding gesture actions in the hand gesture area, and it is more convenient since the user doesn't need to click the button any longer.

### BRIEF DESCRIPTION OF THE DRAWINGS

In order to illustrate the technical schemes in the embodiments of the Invention or in prior art more clearly, the drawings required in description of the embodiments or prior art will be introduced briefly as follows. Obviously, the drawings described below are just a part of the embodiments of the Invention. A person skilled in the art is able to obtain other drawings based on these drawings without any creative work.

The FIGURE is the flow chart of the method for calling out music playlist by hand gesture disclosed in the Invention.

### DETAILED DESCRIPTION OF THE PREFERRED EMBODIMENTS

A clear and full description of the technical schemes of the embodiments of the Invention will be given in combination of the drawings of the embodiments of the Invention as follows. Obviously, the described embodiments are just a part rather than the whole of the embodiments of the Invention. Based on the embodiments of the Invention, any other embodiments obtained by a person skilled in the art without any creative work will fall within the protection scope of the Invention.

I. Basic Flow

As shown in the FIGURE, the invention provides a method for calling out music playlist by hand gesture, wherein, the interface of the music player comprises a number of functional areas. After the user clicks any functional area in use of the music player, the music player will conduct a corresponding operation, for example, if the user click “Playlist” on the interface of the music player, the music player will pop up the music playlist currently played, i.e. call out the music playlist. Compared to the conventional way of clicking button to pop up music playlist, the invention adopts special gesture instead of button operation, fully reflecting the tenet of “Funs infinite” of music lovers, and considering the convenience and novelty of use experience. Most of electronic products like mobile phone are incorporated with hand gesture by virtue of its convenience, intelligence and humanity to provide music lovers more operation options and more fun.

The specific hand gesture comprises ACTION_DOWN operation (i.e. click) and ACTION_MOVE operation. The invention comprises the following steps:

(1) Enter the playing interface of music player. Set up the corresponding plane coordinate system according to the playing interface and set the positive direction of X-axis and Y-axis. Only when the playing interface is accessed can the following steps can be realized in the Invention, where the music player is not required to be always ready for hand gesture operation examination. In this way, improper operation caused by hand gesture can be prevented. In this embodiment, the interface from left to right may be set as the positive direction of X-axis and from upper and down as the positive direction of Y-axis. The playing interface comprises album front cover area, lyrics area and ID3 area respectively, and the album front cover area, lyrics area and ID3 area are arranged on the playing interface in order. ID3 information of the mp3 usually lies in a number of bytes at the beginning or end of an mp3 file added with signer, title, album name, year and style, etc.

(2) Define a hand gesture area in the playing interface, which has overlap areas respectively with album front cover area, lyrics area and ID3 area; for example, if the album front cover area, lyrics area and ID3 area are distributed horizontally, the hand gesture area may be distributed vertically on the playing interface. The size of the hand gesture area may be set according to the screen size of the mobile terminal equipment. Additionally, the hand gesture area may be the whole playing interface. In this embodiment, the hand gesture area may be set on the left side of playing interface. A View algorithm will be defined, then View, mainly ACTION_DOWN and ACTION_MOVE gesture events, will be functionally rewritten. When the hand gesture event of hand gesture area is detected, the music playlist will move out from the left side of the playing interface, and the onTouchEvent needs to be rewritten. When ACTION_DOWN gesture of the area is detected, the current screen coordinate needs to be recorded; then, the View will detect the subsequent ACTION_MOVE event, the displacement of the current ACTION_MOVE may be obtained as per Step (3), (4) and (5).

(3) Check whether there is ACTION_DOWN operation in the hand gesture area. It is the premise to identify hand gesture action favorable to increase accuracy of the invention and avoid improper operation of the user intentionally; if not, keep Wait status or exercise other hand gesture actions; if yes, record the coordinate values of ACTION_DOWN location, and go to the next step;

(4) Judge whether there is ACTION_MOVE operation in the hand gesture area; if yes, record the coordinate values of the ACTION_MOVE location, and then go to the next step;

(5) Obtain the displacement of ACTION_MOVE operation according to the coordinate values of the ACTION_DOWN location and of ACTION_MOVE termination location;

(6) Judge whether the displacement of ACTION_MOVE operation and projection on X-axis are positive. If yes, go to the next step;

(7) Display music playlist in the playing interface.

### II. Function Extension

1. Judge whether there is ACTION_MOVE on the music playlist. If yes, go to the next step;

Obtain the displacement of ACTION_MOVE and judge whether the projection of the displacement on Y-axis is positive; if yes, music playlist moves along the positive direction of Y-axis, otherwise, along the negative direction of Y-axis.

Through the steps above, ACTION_MOVE operation may be realized for the music playlist, and the user can view all songs in the music playlist.

The music playlist contains a number of song entries, one side of which is provided with a dynamic mark for the current song played.

2. Judge whether there is ACTION_MOVE gesture on the playing interface and whether the displacement of ACTION_MOVE gesture projected on X-axis is negative, or whether there is ACTION_DOWN gesture in the area outside the music playlist; or whether to click Return, if yes, the music playlist is folded up.

3. There includes the following steps between Step (3) and Step (4): Judge whether ACTION_DOWN operation is paused. If not, go to Step (4).

4. There includes the following steps between Step (5) and Step (6): set an ACTION_MOVE distance threshold, judge whether the distance of ACTION_MOVE operation exceeds or equals the ACTION_MOVE distance threshold. If yes, go to Step (6).

5. The music playlist is provided with a number of hand gesture subareas, which are respectively set in the areas where the song entries are located;

Judge whether there is ACTION_MOVE gesture in hand gesture area. If yes, judge whether the displacement of ACTION_MOVE gesture has projection along positive direction of X-axis;

If the displacement of ACTION_MOVE has projection along positive direction of X-axis, pop up the music operation list, this comprises the corresponding configuration operation area of song entries and information list.

6. Judge whether the hand gesture subarea has ACTION_DOWN operation. If yes, the corresponding song entry will be played.

7. The music playlist popped up in Step (7) is in scaling mode. When ACTION_MOVE is conducted in the area of music playlist, if the displacement of the ACTION_MOVE has projection in the positive direction of X-axis, the music playlist will be zoomed up, occupying the whole area of playing interface, enabling the user to view more clearly and conveniently, and the song entries in the music playlist zoomed up comprise song name and ID3 information. Such operations as song deletion and song collection under the song name may also be conducted.

Compared to the conventional way of clicking button for response, the Invention has the differences as follows:

A. Different operation way: the conventional operation is to click button, and the Invention is to respond to and pop up the playlist by hand gesture;

B. Different technical difficulty: the operation way of clicking button only needs to identify the coordinate of the point touched for identifying the key types and responding to the corresponding function, while the hand gesture action claimed in the Invention needs to identify the designated gesture in the designated response area, and then pop up the music playlist for operation.

The above are the preferred embodiments rather than the limitations of the Invention. Any amendment, equivalent replacement and improvement made within the range of the spirit and rule of the Invention shall be included in the protection scope of the Invention.

What is claimed is:

1. A method for calling out music playlist by hand gesture, comprising the following steps:
(1) entering playing interface of music player, set up the corresponding plane coordinate system according to the playing interface, and set positive direction of X-axis and Y-axis, the playing interface comprising album front cover area, lyrics area and ID3 area.
(2) defining a hand gesture area in the playing interface, which has overlap areas respectively with album front cover area, lyrics area and ID3 area;
(3) checking whether there is ACTION_DOWN operation in the hand gesture area, if yes, record the coordinate values of the ACTION_DOWN location, and then go to the next step;
(4) judging whether there is ACTION_MOVE operation in the hand gesture area; if yes, record the coordinate values of the ACTION_MOVE location, and then go to the next step;
(5) obtaining the displacement of ACTION_MOVE operation according to the coordinate values of the ACTION_DOWN location and of the ACTION_MOVE termination location;
(6) judging whether the displacement of the ACTION_MOVE operation and projection on X-axis are positive, if yes, go to the next step;
(7) displaying music playlist in the playing interface.

2. The method for calling out music playlist by hand gesture according to claim 1, further comprising the following steps after Step (7):
judging whether there is ACTION_MOVE on the music playlist, if yes, go to the next step; obtaining the displacement of the ACTION_MOVE and judging whether the projection of the displacement on Y-axis is positive, if yes, the music playlist moves along the positive direction of Y-axis, otherwise, along the negative direction of Y-axis.

3. The method for calling out music playlist by hand gesture according to claim 1, further comprising the following steps after Step (7):
judging whether there is ACTION_MOVE on the playing interface and whether the displacement of the ACTION_MOVE projected on X-axis is negative, or whether there is ACTION_DOWN gesture in the area outside the music playlist; or whether to click Return, if yes, the music playlist is folded up.

4. The method for calling out music playlist by hand gesture according to claim 1, wherein, the music playlist contains a number of song entries, one side of which is provided with a dynamic mark for the current song played.

5. The method for calling out music playlist by hand gesture according to claim 2, wherein, the music playlist contains a number of song entries, one side of which is provided with a dynamic mark for the current song played.

6. The method for calling out music playlist by hand gesture according to claim 3, wherein, the music playlist contains a number of song entries, one side of which is provided with a dynamic mark for the current song played.

7. The method for calling out music playlist by hand gesture according to claim 1, further comprising the following steps between Step (3) and Step (4):
judging whether the ACTION_DOWN operation is paused, if not, go to Step (4).

8. The method for calling out music playlist by hand gesture according to claim 1, further comprising the following steps between Step (5) and Step (6):
setting an ACTION_MOVE distance threshold, judging whether the distance of the ACTION_MOVE operation exceeds or equals the ACTION_MOVE distance threshold, if yes, go to Step (6).

9. The method for calling out music playlist by hand gesture according to claim 4, wherein, the music playlist is provided with a number of hand gesture subareas, which are respectively set in the areas where the song entries are located; the method further comprises:
judging whether there is ACTION_MOVE gesture in the hand gesture subarea, if yes, judge whether the displacement of the ACTION_MOVE gesture has projection along positive direction of X-axis;
if the displacement of the ACTION_MOVE has projection along positive direction of X-axis, popping up the music operation list, which comprises the corresponding configuration operation area of song entries and information list.

10. The method for calling out music playlist by hand gesture according to claim 5, wherein, the music playlist is provided with a number of hand gesture subareas, which are respectively set in the areas where the song entries are located; the method further comprises:
judging whether there is ACTION_MOVE gesture in the hand gesture subarea, if yes, judge whether the displacement of the ACTION_MOVE gesture has projection along positive direction of X-axis;
if the displacement of the ACTION_MOVE has projection along positive direction of X-axis, popping up the music operation list, which comprises the corresponding configuration operation area of song entries and information list.

11. The method for calling out music playlist by hand gesture according to claim 6, wherein, the music playlist is provided with a number of hand gesture subareas, which are respectively set in the areas where the song entries are located; the method further comprises:
judging whether there is ACTION_MOVE gesture in the hand gesture subarea, if yes, judge whether the displacement of the ACTION_MOVE gesture has projection along positive direction of X-axis;
if the displacement of the ACTION_MOVE has projection along positive direction of X-axis, popping up the music operation list, which comprises the corresponding configuration operation area of song entries and information list.

12. The method for calling out music playlist by hand gesture according to claim 9, further comprising: judging whether the hand gesture subarea has ACTION_DOWN operation, if yes, the corresponding song entry will be played.

13. The method for calling out music playlist by hand gesture according to claim 10, further comprising: judging whether the hand gesture subarea has ACTION_DOWN operation, if yes, the corresponding song entry will be played.

14. The method for calling out music playlist by hand gesture according to claim 11, further comprising: judging whether the hand gesture subarea has ACTION_DOWN operation, if yes, the corresponding song entry will be played.
